(19) United States
(12) Patent Application Publication
(10) Pub. No.: US 2026/0368250 A1
(43) Pub. Date: Nov. 19, 2026

(54) Real-Time Generation of Natural-Sounding Audio Content Integrating Third-Party Content

(71) Applicant: Google LLC, Mountain View, CA (US)

(72) Inventors: Lakshmi Kumar Dabbiru, Santa Clara, CA (US); Raghavendra Rao Donamukkala, San Jose, CA (US)

(21) Appl. No.: 19/209,484

(22) Filed: May 15, 2025

(51) Int. Cl. G06F 16/683; G10L 13/027

(52) U.S. Cl. CPC G06F 16/685; G10L 13/027

(57) ABSTRACT

This present disclosure describes a system and method for generating audio content with integrated third-party content. The method includes processing context data with a machine-learned model to create an initial transcript for audio content, accessing a user query, transmitting a request for a content item related to the query and context data, receiving the content item, and processing it with the machine-learned model to generate an updated transcript. The updated transcript incorporates the content item and seamlessly transitions from the initial transcript. This technology can be used to dynamically insert contextually relevant content items into audio streams, such as AI-generated podcasts, enhancing user engagement.

### FIELD

The present disclosure relates generally to machine learning processes and machine-learned devices and systems. More particularly, the present disclosure relates to real-time generation of natural-sounding audio content integrating third-party content.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include processing a corpus of context data with a machine-learned model to generate, as output from the machine-learned model an initial transcript for audio content. The initial transcript can include description of one or more topics contained within the context data. The method can include accessing data indicative of a user query. The method can include transmitting a request for a content item comprising the user query and the context data. The method can include receiving, responsive to the request for the content item, a first content item. The method can include processing the first content item with the machine-learned model to generate, as output from the machine-learned model an updated transcript for audio content. The transcript can include a transition from the initial transcript to a transcript that incorporates the first content item.

Example aspects of the present disclosure provide one or more example non-transitory computer-readable media storing instructions that are executable by one or more processors to cause a computing system to perform example operations. In some implementations, the example operations can include processing a corpus of context data with a machine-learned model to generate, as output from the machine-learned model an initial transcript for audio content. The initial transcript can include description of one or more topics contained within the context data. The operations can include accessing data indicative of a user query. The operations can include transmitting a request for a content item comprising the user query and the context data. The operations can include receiving, responsive to the request for the content item, a first content item. The operations can include processing the first content item with the machine-learned model to generate, as output from the machine-learned model an updated transcript for audio content. The transcript can include a transition from the initial transcript to a transcript that incorporates the first content item.

Example aspects of the present disclosure provide an example computing system that includes one or more processors and one or more example non-transitory computer-readable media storing instructions that are executable by one or more processors to cause a computing system to perform example operations. In some implementations, the example operations can include processing a corpus of context data with a machine-learned model to generate, as output from the machine-learned model an initial transcript for audio content. The initial transcript can include description of one or more topics contained within the context data. The operations can include accessing data indicative of a user query. The operations can include transmitting a request for a content item comprising the user query and the context data. The operations can include receiving, responsive to the request for the content item, a first content item. The operations can include processing the first content item with the machine-learned model to generate, as output from the machine-learned model an updated transcript for audio content. The transcript can include a transition from the initial transcript to a transcript that incorporates the first content item.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a graphical diagram of an example audio generation system according to example implementations of aspects of the present disclosure;

FIG. 2 is a graphical diagram of an example audio generation system according to example implementations of aspects of the present disclosure;

FIG. 3 depicts a flow chart diagram illustrating an example method for transcript generation and re-writing to integrate third-party content according to example implementations of aspects of the present disclosure;

FIG. 4 is a graphical diagram of an example audio generation system according to example implementations of aspects of the present disclosure;

FIG. 5 is a graphical diagram of an example audio generation system according to example implementations of aspects of the present disclosure;

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

### DETAILED DESCRIPTION

The present disclosure generally relates to automatic generation of natural-sounding audio content from a variety of input data. The proposed systems and methods can provide for dynamically inserting contextually relevant content by generating updated transcripts that incorporate selected content items into the transcript. The updated transcripts can be generated while audio playback of the initial transcript is being provided for display. This can provide for seamless integration of such content without introducing latency or otherwise interrupting the conversation flow of the audio playback of the initial transcript.

In some instances, the present disclosure can provide for a condition determination as to whether a content item should be selected and integrated into the transcript. For instance, the technology of the present disclosure can provide for identification of topics that can be associated with "commercial intent breaks" using machine learned models, such as large language models (LLMs), and can employ asynchronous calls to content servers to obtain content item(s) that are relevant to identified topics. By generating updated transcripts which incorporate the content item(s) within a transcript associated with the initial topic of the transcript, the technology of the present disclosure can provide for continuity and relevance.

Current approaches for providing content generally apply to more static use cases such as within a search interface, among user generated content, or other surfaces which provide for a more uniform display of content to various users. As such, these approaches fail to adequately provide for dynamic and on-demand integration of content within machine-learned model generated transcripts (e.g., AI-generated podcasts). Unlike other platforms where content items are algorithmically placed against user-generated content, the real-time generation of transcripts and associated audio content presents unique challenges in identifying appropriate moments for content item integration while reducing latency associated with transcript generation and content item retrieval.

The present disclosure provides several technical effects and benefits. For instance, by employing asynchronous calls to content servers or preselecting a subgroup of content items associated with a topic of the transcript, the system can reduce latency and maintain a natural conversational flow. The present disclosure utilizes machine-learned models such as large language models (LLMs) to perform topic detection. This process enables content to be inserted at highly appropriate points within the AI-generated podcast, resulting in less AI-podcast script that must be re-written. Additionally, this can provide for a preselection of a sub-group of relevant content items which can reduce the computing resources required at inference time to select a content item (e.g., reducing the number of potentially available content items). The ability to customize content insertion based on an intent of a user's query or topic of the AI-generated podcast can further improve the relevance and effectiveness of the content. The structure of the system that implements the technology described herein can provide for enhanced control over the flow of information and the ability to generate responses in real time in line with a user's request.

By using machine-learned models to generate and dynamically modify transcripts associated with a corpus of context data, the system overcomes limitations inherent in traditional podcasts, where content items are fixed and pre-defined. Moreover, unlike user-generated content platforms, the present disclosure leverages machine-learned models to inject content items seamlessly into the content itself, creating a highly contextual and relevant experience for the user. This is particularly challenging, as the insertion needs to occur while maintaining natural conversation flow, and at a scale, breadth, and personalization that human intervention alone could not achieve efficiently.

Asynchronous content item calls manage and mitigate latency, while context restitching guarantees consistency. Machine-learned model's control extends to the adjustment of content item delivery and content relevance in real-time based on the inferred commercial interest of user queries. By managing and delivering customized content directly within a dynamic audio stream, the system resolves the technical problem of integrating real-time content items into transcripts which are transformed into audio (e.g., AI podcasts). This goes beyond simple automation of content item placement. It offers a tangible and valuable contribution by directly modifying the transcripts to ensure coherence and relevance to both the user and the content provider.

Various example implementations are described herein with respect to the accompanying Figures.

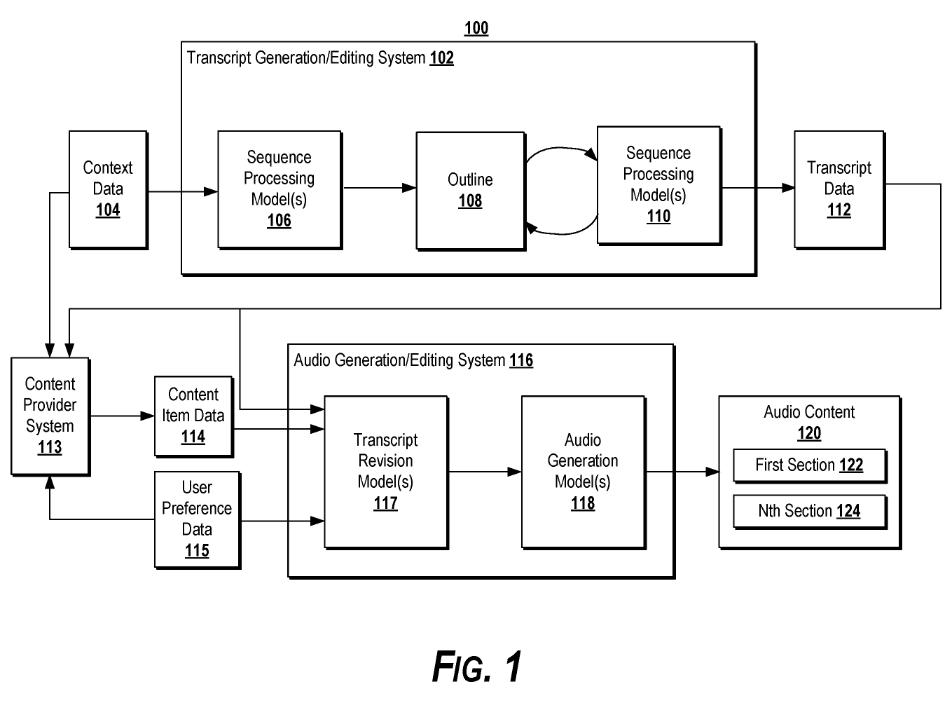

FIG. 1 depicts an example audio generation system 100. Transcript generation/editing system 102 can obtain context data 104 as input and generate transcript data 112 as output. Audio generation/editing system 116 can process transcript data 112, content item data 114, or user preference data 115 to generate audio content 120 as output. Content provider system 113 can process context data 104, transcript data 112, and/or user preference data 115 to select one or more relevant content items and transmit content item data 114 to audio generation/editing system 116.

Transcript generation/editing system 102 can include sequence processing model(s) 106. Sequence processing model(s) 106 can process context data 104 to generate outline 108. Outline 108 can include a set of sections, each section corresponding to an individual topic or section of context data 104. Sequence processing model(s) 106 can then process each section of context data 104 to generate corresponding transcript data 112. Transcript generation/editing system 102 can provide transcript data 112 as input to audio generation/editing system 116.

In some instances, sequence processing model(s) 110 can perform a rewrite process of outline 108 until outline 108 is satisfactory. Then sequence processing model(s) 110 can generate transcript data 112 as output.

In some instances, sequence processing model(s) 106 can process segment rules. Segment rules can include a dictionary for rules that are associated with a particular vertical (e.g., weather updates, news, educational). In some instances, grounding can be performed by sequence processing model(s) 106 as described herein.

In an example embodiment, transcript generation/editing system 102 can generate transcript data 112 in an offline process and audio generation/editing system 116 can generate revised transcripts via transcript revision model 117 which can be used by audio generation model(s) 118 to generate audio content 120 in an online process.

In some instances, the transcript generation/editing system 102 can perform the more computationally intensive task of generating accurate and detailed transcripts offline. The offline process can be completed separately from any user interaction and can typically involve heavy computation tasks. The offline process can allow for pre-calculation and preparation of resources, like transcripts, before real-time use. This approach helps optimize performance and responsiveness in applications needing quick data delivery.

In an example embodiment, content item data 114 including one or more candidate content items can be selected in an offline process and stored or otherwise associated with transcript data 112 such that there are a smaller number of candidate items for audio generation/editing system 116 to consider during an online audio content generation process.

By having a smaller candidate pool of content items to be selected from when a user requests audio content to be played-back, latency can be reduced by preventing the need for real-time selection of content items by content provider system 113.

In some instances, content provider system 113 can select one or more content items and generate content item data 114 in a real-time content selection process.

In some instances, the audio generation/editing system 116 then leverages these pre-generated transcripts to create natural-sounding audio in real-time, enabling immediate playback and interactivity. An online process refers to actions performed in real-time and directly influenced by active user engagement. It involves immediate processing and generation of content during a live session, rather than pre-computed outputs. The audio generation/editing system can then utilize the transcript data 112, content item data 114, and/or user preference data 115 to synthesize natural-sounding audio dynamically that seamlessly incorporates content item data 114 into the audio content.

For example, transcript generation/editing system 102 can obtain context data 104 for a large corpus of input data on a regular basis (e.g., daily, weekly, monthly, etc.). By way of example, context data 104 can include a number (e.g., hundreds, thousands, millions) of textual documents, audio files, and/or video files. In some examples, context data 104 can include a number of distinct news stories.

In an example embodiment, audio generation/editing system 116 can create audio content 120 without requiring large amounts of computational power. For instance, audio generation model(s) 118 can be trained using a combination of tuning using a large dataset and distillation lessons from a larger audio generation model. As such, audio generation model(s) 118 can be smaller models that reduce the computation loads associated with generation of audio content 120 while providing output complying with desired criteria such as voice, tone, and/or emotional characteristics.

Audio content 120 can include at least first section 122 and nth section 124. In some instances, audio content 120 can include a number of distinct sections which can be independently generated. Audio generation/editing system 116 can be called based on user interaction requesting audio content (e.g., a podcast) related to one of the topics in context data 104. Responsive to obtaining the request for audio content, audio generation/editing system 116 and process transcript data 112, content item data 114, and/or user preference data 115 to generate audio content aligning with the transcript, one or more selected content items of content item data, and preference data. For instance, user preference data can include user persona, language code, voices, characters, or other relevant preferences. In some instances, content item data 114 can include a content item persona associated with the third-party that generated the content, the subject matter of the content item to be discussed, or any restrictions or requirements associated with displaying the content. As such, transcript data 112 generated in one language can be used to generate audio content in a different language. Additionally, or alternatively, based on a user preference for a character or voice, two users requesting a podcast for the same topic can receive different, customized, audio content 120. In some instances, two users requesting a podcast for the same topic can receive different audio content incorporating different candidate content items from content item data 114.

Section of the audio content can correspond to portions of transcripts that incorporate content item data 114. In some instances, content item data 114 can be introduced using a transition that highlights that the next segment is associated with a particular product, service, or otherwise is distinguishable from the audio content generated based on the context data 104. Sections of the audio content 120 can correspond to portions of revised transcripts. Additionally, or alternatively, sections of the audio content 120 can correspond to sections of content divided based on topics or sub-topics.

Audio generation/editing system 116 can provide audio content 120 for display to an end user device such that the user can interact with the audio content 120 such that the user can ask questions (e.g., questions directed to a topic being discussed, questions relating to a product or service, etc.), the audio generation/editing system 116 can respond with an answer (e.g., an answer to the question, a summary of the topic being discussed, etc.).

As an example, a first section 122 can be associated with a revised transcript associated with context data 104 and transcript data 112 and Nth section 124 can be associated with a transcript that incorporates content item data 114. For instance, Nth section 124 can be generated based on a question received from a user.

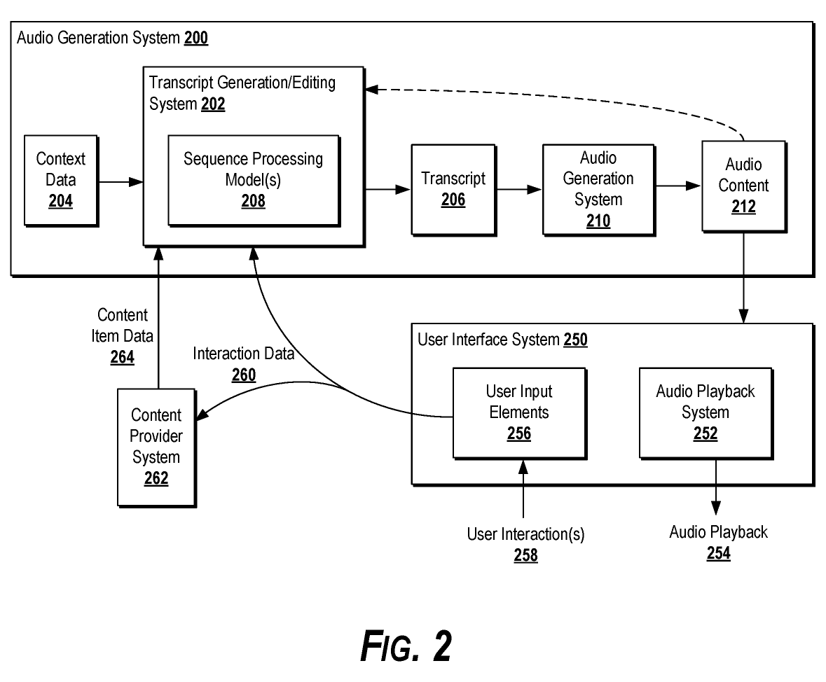

FIG. 2 depicts an example audio generation system 200. The audio generation system 200 can automate the generation of audio content from various types of context data through a series of computational steps.

The audio generation system 200 includes a transcript generation/editing system 202, which receives context data 204. The context data 204 can include textual documents, audio files, and/or video content. In some implementations, context data 204 can be converted into a textual format before further processing. The sequence processing model(s) 208 within the transcript generation/editing system 202 are tasked with processing this context data 204 to generate a transcript 206. The transcript 206 may be a structured transcript that includes descriptions of topics contained within the context data 204.

This transcript 206 is then input into the audio generation system 210, which converts the transcript 206 into audio content 212. In some implementations, this conversion can be achieved through a machine-learned voice model that ensures the speech content verbalizes the transcript accurately. Once the audio content 212 is generated, it can be streamed to users via a real-time communication framework as part of the playback process. In some implementations, the audio generation system 200 is implemented by a server system comprising one or more server computing devices.

Additionally, FIG. 2 illustrates a user interface system 250 that enables user interaction with the audio content 212. The user interface system 250 can include an audio playback system 252 that can facilitate playback (e.g., via one or more speakers) of the audio content 212 to a user.

The user interface system 250 can also include user input elements 256, which can receive user interactions 258 from the user. The user input elements 256 can transform the user interactions 258 into interaction data 260 which is provided back to the audio generation system (e.g., specifically to the transcript generation/editing system 202) and/or content provider system 262.

Content provider system 262 can process interaction data 260 and generate content item data 264 as output. Content provider system 262 can communicate with one or more content servers or third-party content providers to select content items relevant to context data 204 and/or interaction data 260. For instance, one or more content selection processes can be employed to select one or more content items and associated data that are relevant to the subject matter described in context data 204. As described herein, content item data 264 can include a number of candidate content items or a single selected content item. The content item data 264 can be generated based on content that is relevant to a query received from one or more users. For instance, after a user indicates a query, content provider system 262 can process the query to identify a set of content items from one or more content servers that are relevant to the query. Responsive to generating the content item data 264, the content provider system 262 can provide the content item data 264 for transmission to the transcript generation/editing system 202.

The transcript generation/editing system 202 can use the interaction data 260 and/or content item data 264 to revise, edit, or otherwise influence the content generation process. For example, content item data 264 can include a third-party content item. The third-party content item can be related to a specific topic and have associated data relating to the manner in which the content should be provided for display to a user. By way of example, the associated data can include a persona, or other requirements for how a topic is discussed. For instance, this can include brand guidelines or other guidelines set by a third-party for discussing the product, service, or other subject matter of the content item. In some instances, a content item can include a third-party content item such as an advertisement. For example, the interaction data 260 may include user commands or feedback that the sequence processing model(s) 208 use to adjust the transcript 206 in real-time.

In some implementations, the audio playback system 252 further manages the playback of the audio content 212 so that it is controlled relative to or based on any user interactions 258, such as questions or commands that might alter the flow of the content. Furthermore, the user interface system 250 can display attribution or citation elements that are synchronized with the audio playback, providing users with additional information about the sources of the content they are listening to.

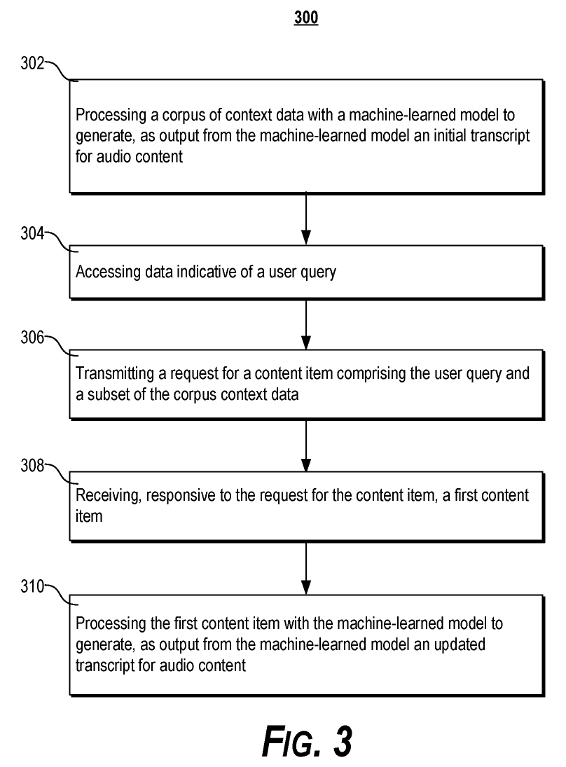

FIG. 3 illustrates a flowchart of a method 300 for incorporating third-party content into audio content according to example implementations of aspects of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by a server computing system (e.g., server computing system 60) or client computing system (e.g., client computing device 50). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment.

At operation 302, processing logic can process, by a computing system, a corpus of context data with a machine-learned model to generate, as output from the machine-learned model an initial transcript for audio content. The initial transcript can include description of one or more topics contained within the context data. For instance, the corpus of context data can include a large corpus of textual documents, audio files, or video files.

The initial transcript can be associated with a plurality of pre-selected content items. The first content item can be an item of the plurality of pre-selected content items.

In some instances, the context data can be converted into a textual format before further processing. In some instances, processing the corpus of context data includes processing the corpus of context data via the machine-learned model to generate, as output from the machine-learned model a sequence of topics, each topic of the sequence of topics corresponding to a topic or section of the corpus of context data. In some instances, a corpus of context data can include one or more third-party content items associated with the topics or other portions of context data. The third-party content items can be indexed such that relevant content items associated with a portion of the context data can be more easily retrieved with reduced latency.

At operation 304, processing logic can access data indicative of a user query. The user query can include a question relating to a topic described within the initial transcript. For instance, the data indicative of a user query can include a user query for information contained within the corpus of context data, such as a follow-up question.

For instance, the context data can include a description of a topic such as "how to get the best return on a new build." The context data can include data associated with common pitfalls associated with new build homes, best finishes to choose for a home based on budget, information associated with appliances, common items left off of punch lists, or anything else that would be helpful for an individual that is purchasing, or has already purchased, a home that is a "new build." A user query could be related to a particular topic of the number of topics covered in the context data. By way of example, the user query could be a request for "best washers/dryers under $2,000".

At operation 306, processing logic can transmit a request for a content item comprising the user query and a subset of context data of the corpus of context data. For instance, a request for a content item associated with "best washers/dryers under $2,000" and information associated with the context data such as "how to get the best return on a new build" can be transmitted to the content provider system. Content provider system can determine one or more content items relevant to the user query and the context data. For instance, content provider can have a number of content items associated with washers and/or dryers or other appliances. As such, content provider system can select one or more content items and provide them to the requesting system.

At operation 308, processing logic can receive, responsive to the request for the content item, a first content item. The first content item can include a product and a description of the product. The first content item can include an outline for a transcript. The first content item can include a preselected voice to be used for audio content that is generated from the updated transcript.

For instance, continuing with the "how to get the best return on a new build" example, the first content item can be an item relevant or associated with washers and/or dryers. The first content item can be associated with a persona and a description of the subject matter of the first content item. In some instances, the first content item can include an initial transcript associated with the content. In some instances, the first content item can include an outline for a transcript. In some instances, the first content item can include a preselected voice to be used for audio content that is generated from the updated transcript. In some instances, the first content item can include a transition to indicate that the first content item is distinct from the initial transcript generated based on context data.

In some instances, the initial transcript or updated transcript can be generated by a machine-learned model. For example, the machine-learned model can include a large language model (LLM). In some implementations the LLM can be associated with a content provider computing system. By way of example, the LLM can be a fine-tuned model or model that is trained using distillation. In some implementations, the LLM can be continually tuned based on feedback provided by third parties that provide content to the content provider system.

At operation 310, processing logic can process, by the computing system, the first content item with the machine-learned model to generate, as output from the machine-learned model an updated transcript for audio content. The transcript can include a transition from the initial transcript to a transcript that incorporates the first content item.

In some instances, the updated transcript can include a first updated transcript and a second updated transcript. For instance, processing logic can generate the second updated transcript comprising speech content that is generated while first audio content generated from the first updated transcript is being provided for playback. For instance, processing logic can provide second audio content generated from the second updated transcript for playback after the first audio content is completed being provided for playback.

In some instances, the transition from the initial transcript to a transcript that incorporates the first content item can be generated while audio content generated based on the initial transcript is provided for playback. It can be technologically beneficial to integrate the content item at the transcript re-write phase opposed to directly inserting audio content. This allows for personalization of the transcript to fit in with the topics discussed or described in the corpus of context data while seamlessly integrating the content associated with the content item. Instead of a simple insertion into a window, this can provide for real-time stitching and updating of a transcript which can provide for real-time re-generation of audio content to be provided to a user. Such as, via audio playback. The intermediary data associated with the transcript can be more easily manipulated or rewritten as compared to manipulating audio data as such. In some instances, an initial content item can include an audio, video, or visual content item. Processing logic can process an initial content item to generate an outline, transcript, or some sort of data structure representing the content item. Processing logic can access the data structure representing the content item and manipulate the data structure to integrate the content into the updated transcript. As such, the present disclosure can provide for an improvement to technology of machine learning and real-time audio content generation.

The updated transcript can be generated by a machine-learned model. For instance, the machine-learned model can integrate one or more content items into the updated transcript. In some instances, the content items can include data associated with requirements for when the transcript is turned into audio. For instance, this can include a persona or voice or other characteristics of the audio that is displayed. In some instances, the updated transcript can include a conversational transcript. In some instances, the updated transcript can include a monologue by a persona associated with the content item. As such, the transition can include language indicating that there will be a shift from the initial transcript to a transcript incorporating the one or more content items.

Processing logic can process the updated transcript to generate audio content. Processing logic can provide the audio content for playback.

While the present disclosure provides an embodiment where a content item is selected and integrated into audio content that is generated based on a corpus of context data, it can be understood that a transcript can be generated based on content item data and provided to an audio generation system for display to a user. For instance, an independent, personalized audio content item can be generated and provided for display to a user. An example implementation can include, for example, an extension in a search interface, wherein responsive to obtaining a user query, a personalized audio content item can be generated and provided as a selectable user interface element in the search interface. For instance, a user can click a link and the audio content can be provided for display, such as, via a speaker of a user device.

In some implementations, processing logic can generate an explanation associated with a content item provided near a search result. For instance, processing logic can determine that a third-party content item may not be completely self-explanatory. As such, processing logic can generate a natural language explanation of why the third-party content item is relevant.

For instance, responsive to a user selecting a link, processing logic can generate a transcript associated with a third-party content item. The transcript can be processed by an audio generation model to generate audio for playback. In some instances, the transcript generation and audio generation can be performed by a single model. In some instances, a third-party content provider can maintain a model context protocol server to answer questions associated with controls for content items. The controls for content items can include, for example, brand or messaging information.

In some implementations, processing logic can determine a break associated with the initial transcript. For instance, a break can be a time at which the transcript transitions from a first topic to a second topic. Processing logic can determine that the break is associated with a commercial intent. For instance, associated with recommending particular types of appliances. As such, processing logic can determine that a third-party content item associated with appliances would naturally fit in that portion of the transcript. Based on determining the commercial intent break, processing logic can perform a content selection process and update the transcript to incorporate the third-party content item that is selected. In some instances, the generation of a commercial intent break can be based at least in part on the number of prior commercial intent breaks and/or a proximity to one or more commercial intent breaks.

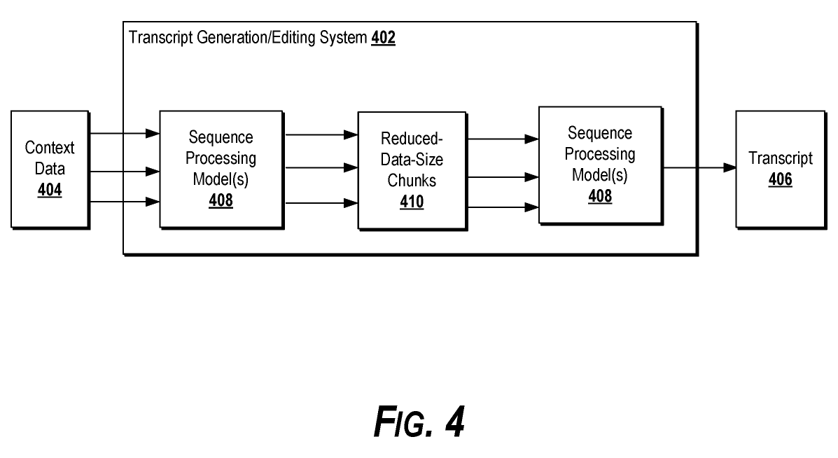

FIG. 4 illustrates an example workflow within an example transcript generation/editing system 402 of the audio generation system. This diagram demonstrates the step-by-step process for transforming context data into a structured transcript that can be converted into audio content.

The process starts with the context data 404, which can include various forms of data such as text, audio, or video. This data is input into the sequence processing model(s) 408, which are designed to analyze and process the data. Specifically, the transcript generation/editing system 402 can first segment the context data 404 into smaller, more manageable chunks. These smaller chunks can then be processed by the sequence processing model(s) 408 to generate reduced-data-size chunks 410. This segmentation and data size reduction simplifies the complexity of the data, making it easier for further processing.

Following the creation of reduced-data-size chunks 410, these chunks are again processed by the sequence processing model(s) 408. This subsequent processing can include a deeper analysis and synthesis of the data to construct a coherent and comprehensive transcript 406. This transcript is then ready to be fed into an audio generation system where it will be converted into speech content.

The process can be performed for a number of chunks of audio data. For instance, this can be performed based on the corpus of context data and/or content items.

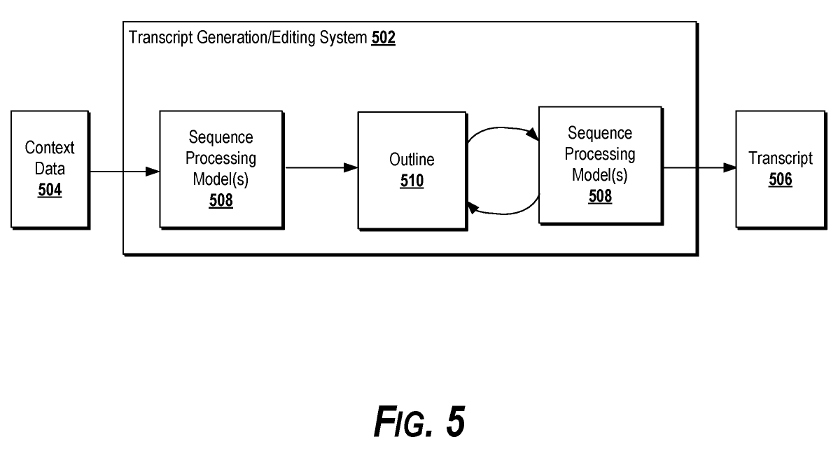

FIG. 5 illustrates a schematic representation of an example workflow within a transcript generation/editing system 502. This system is designed to process context data and generate a structured transcript suitable for conversion into audio content.

The process begins with context data 504, which can include various types of information such as textual documents, audio files, or video content. The context data 504 is fed into the sequence processing model(s) 508, which are responsible for analyzing the context data and extracting relevant information. These models can be machine-learned models trained to process large datasets and identify key elements necessary for generating a transcript.

Following the initial processing, the output of the model(s) 508 can include an outline 510 or other hierarchical structure for generation of the transcript. The outline 510 can organize the extracted information and/or transcript into a structured format, dividing the content into sections or topics. This structured outline 510 serves as a framework for the subsequent detailed transcript generation.

The outline 510 is then fed back into the sequence processing model(s) 508. In this stage, the models process each section of the outline iteratively, ensuring that the detailed content for each section is accurately and comprehensively developed. This iterative processing helps in maintaining the logical flow and coherence of the final transcript.

The final output from the sequence processing model(s) 508 is the transcript 506. The transcript 506 is formatted according to the structured outline. This transcript is then ready to be converted into speech content in further processing steps not shown in FIG. 5.

The process can be performed for a number of chunks of audio data. For instance, this can be performed based on the corpus of context data and/or content items.

In some instances, the transcript and audio generation process can include the integration of critic-driven feedback loops for refining transcripts.

The process can start with context data, which can include a variety of information sources such as text, audio, and video data. This context data is input into the sequence processing model(s), which analyzes the data to extract relevant information and generate an initial transcript. The initial transcript represents a preliminary version of the textual content derived from the context data. In some instances, the initial transcript can include designations where third-party content items can be naturally integrated.

Once the initial transcript is generated, it is subjected to a critique process. Critique instruction(s) provide guidelines or parameters that define the aspects of the transcript to be reviewed and the nature of the feedback desired. These instructions can specify areas to focus on, such as accuracy, clarity, style, or adherence to specific informational priorities.

The sequence processing model(s) then use the critique instruction(s) to assess the initial transcript and generate critique(s). The critique(s) can include feedback that identifies potential improvements or corrections needed in the initial transcript. This feedback can include suggestions for rewording, adding missing information, correcting errors, or enhancing the flow and naturalness of the text.

Following the generation of the critique(s), the sequence processing model(s) reprocess the initial transcript in light of the critique(s). This iterative loop allows for the refinement of the transcript, aiming to address the issues highlighted in the critique(s) and improve the overall quality of the transcript. The refined transcript is then output as a transcript, which is a more polished and/or accurate representation of the context data.

In some implementations, audio content generated from the initial transcript can be used by the model(s) when generating the critique(s). For example, this may enable the model(s) (when acting as critic(s)), to have insight into the actual final audio product. For example, this may enable the detection of verbalization errors.

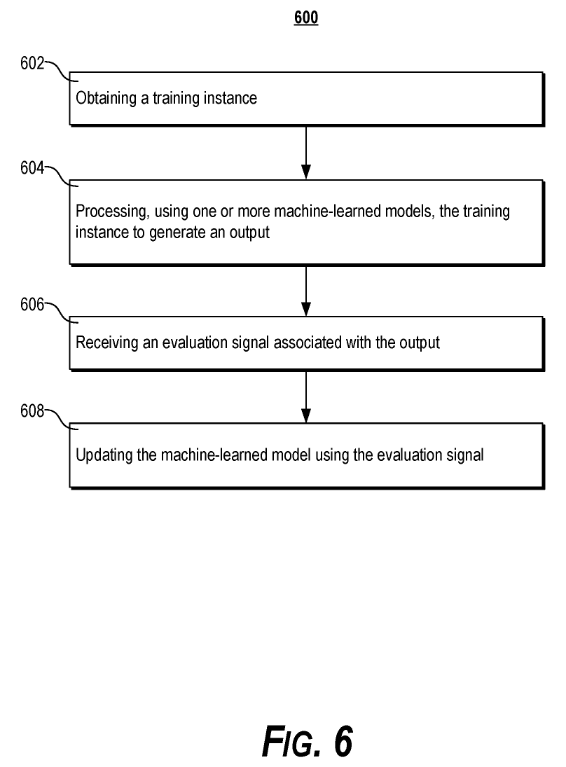

FIG. 6 depicts a flowchart of a method 600 for training one or more machine-learned models according to aspects of the present disclosure. For instance, an example machine-learned model can include a sequence processing model, machine-learned model, large language model (LLM), and/or content selection model.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types.

In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 600 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 600 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

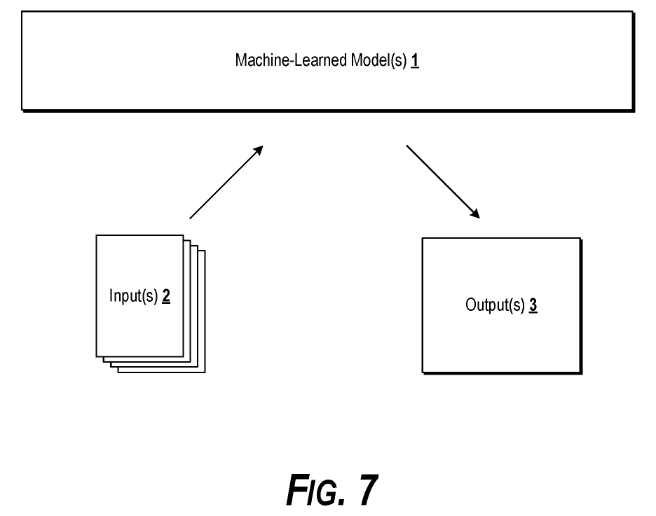

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of a sequence processing model, machine-learned model, large language model (LLM), and/or content selection model, etc. Although various features, variations, and implementations described below are described with respect to machine-learned model(s) 1, it is to be understood that such features, variations, and implementations are to be understood as described with respect to each of a sequence processing model, machine-learned model, large language model (LLM), and/or content selection model, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

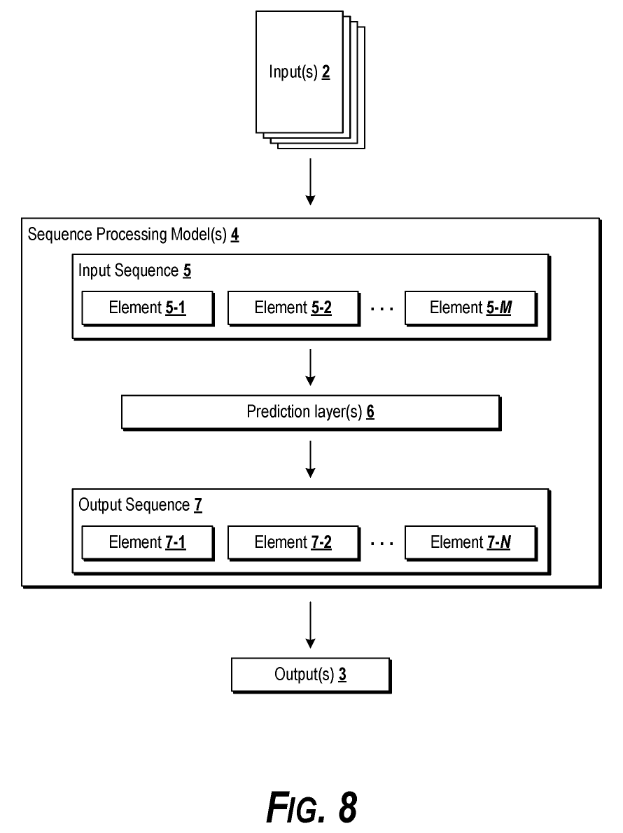

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, Google, https://arxiv.org/abs/2403.08295; Gemma 2: Improving Open Language Models at a Practical Size, Google, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google, https://arxiv.org/abs/2407.07726; PaliGemma 2: A Family of Versatile VLMs for Transfer, Google, https://arxiv.org/abs/2412.03555; Flamingo: a Visual Language Model for Few-Shot Learning, Google, https://arxiv.org/abs/2204.14198; PaLI: A Jointly-Scaled Multilingual Language-Image Model, Google, https://arxiv.org/abs/2209.06794.

Sequence processing model(s) 4 can be multimodal. Example multimodal sequence processing models include, for instance, models described in Gemini: A Family of Highly Capable Multimodal Models, Google, https://arxiv.org/abs/2312.11805; Gemini 1.5: Unlocking multimodal understanding across millions of tokens of context, Google, https://arxiv.org/abs/2403.05530.

Other example sequence processing models can operate to generate outputs or receive inputs in specific domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 8 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

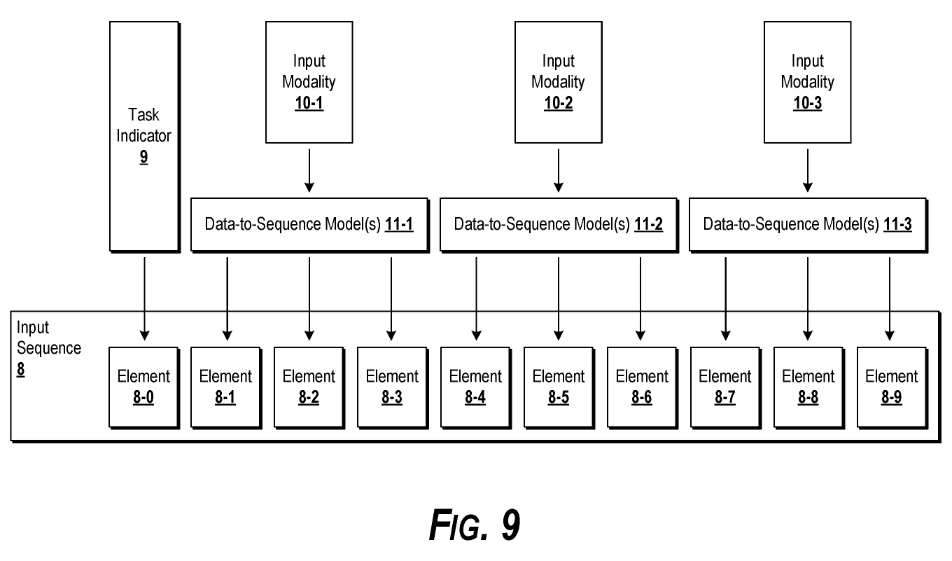

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

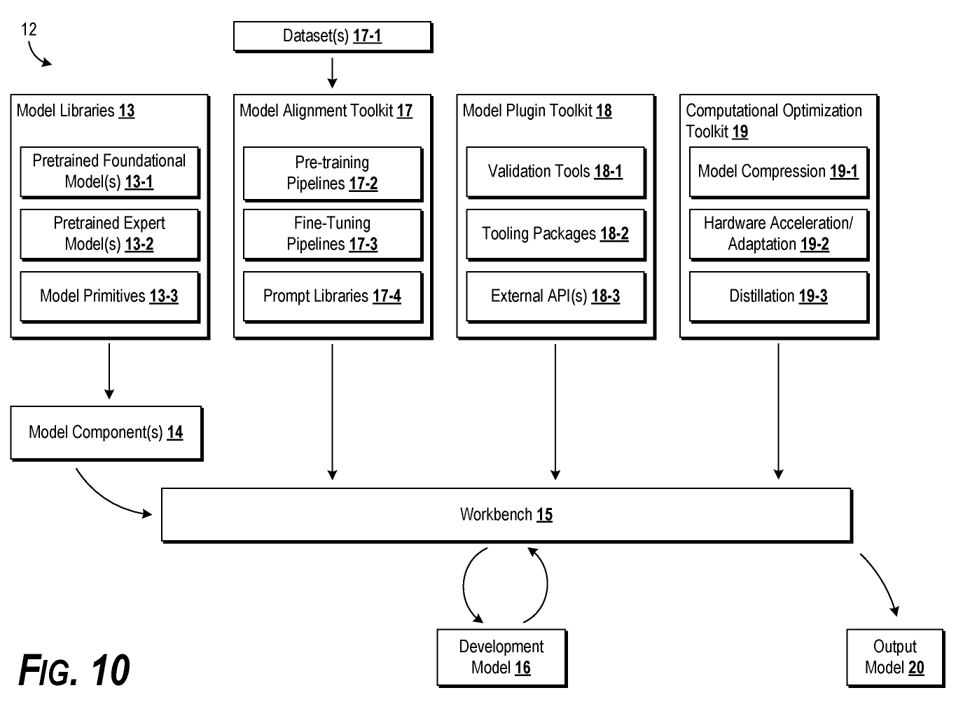

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

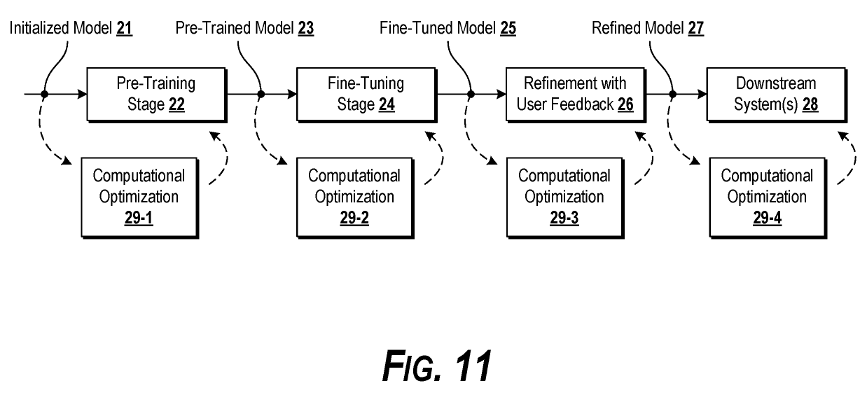

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

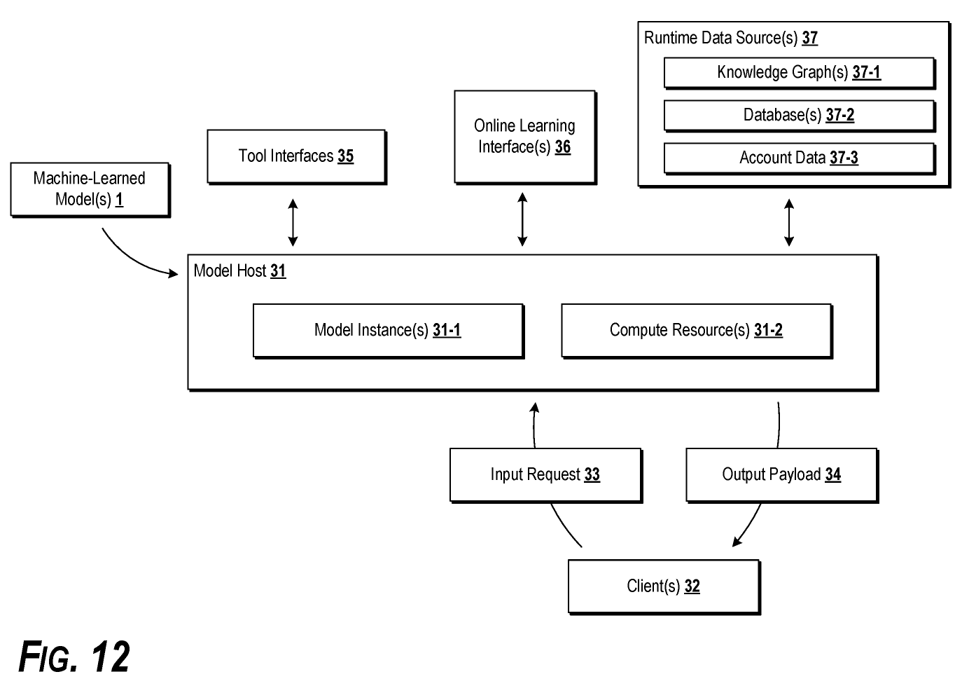

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

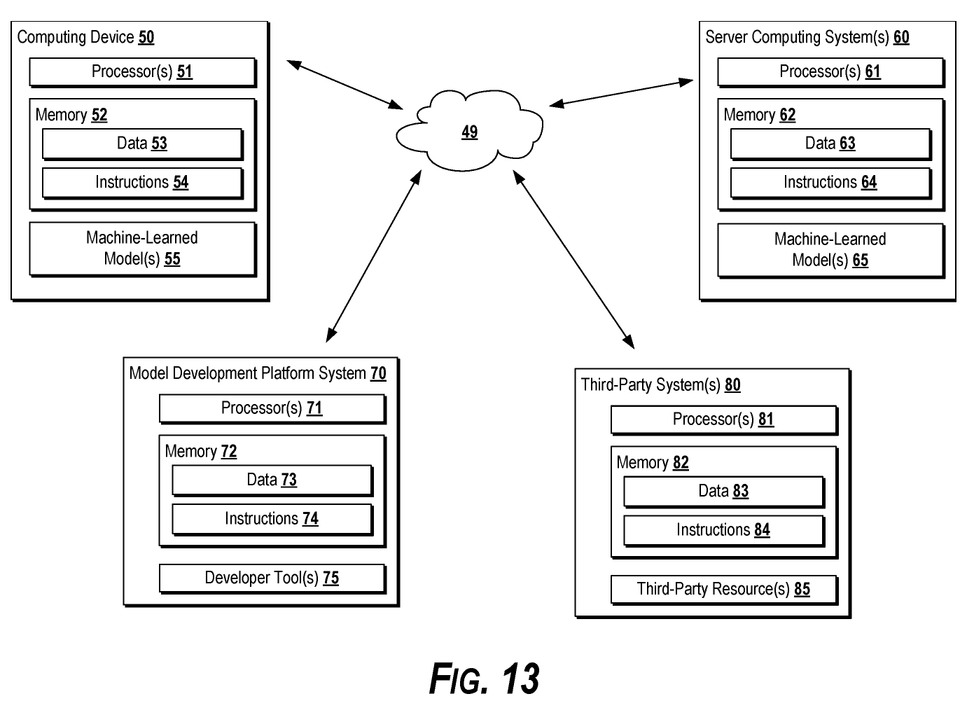

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third-party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third-party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s85) ).

FIG. 13illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

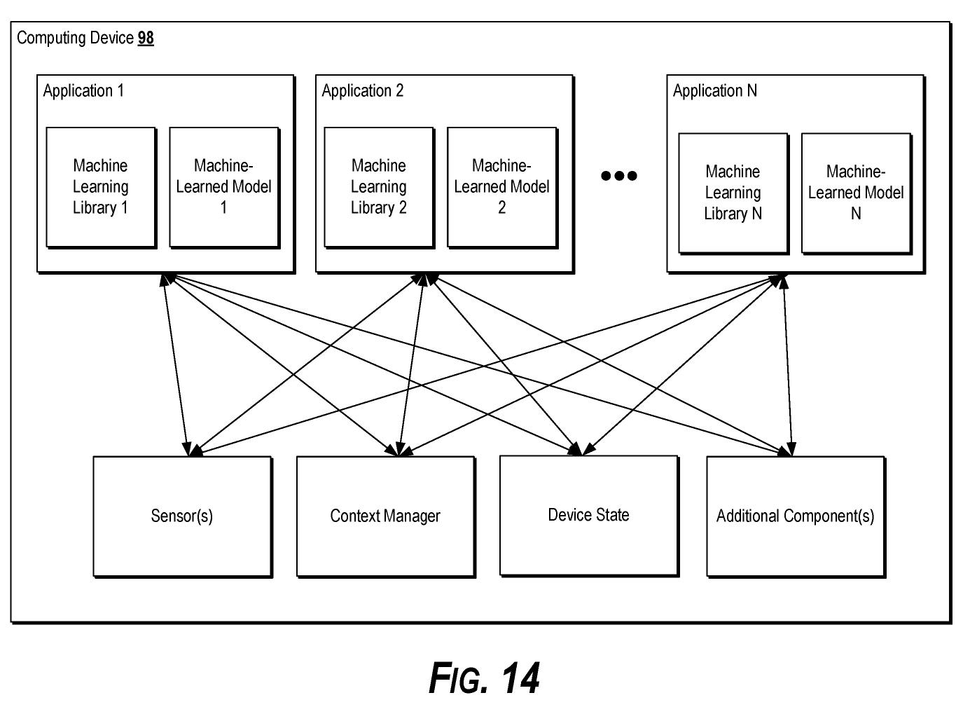

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

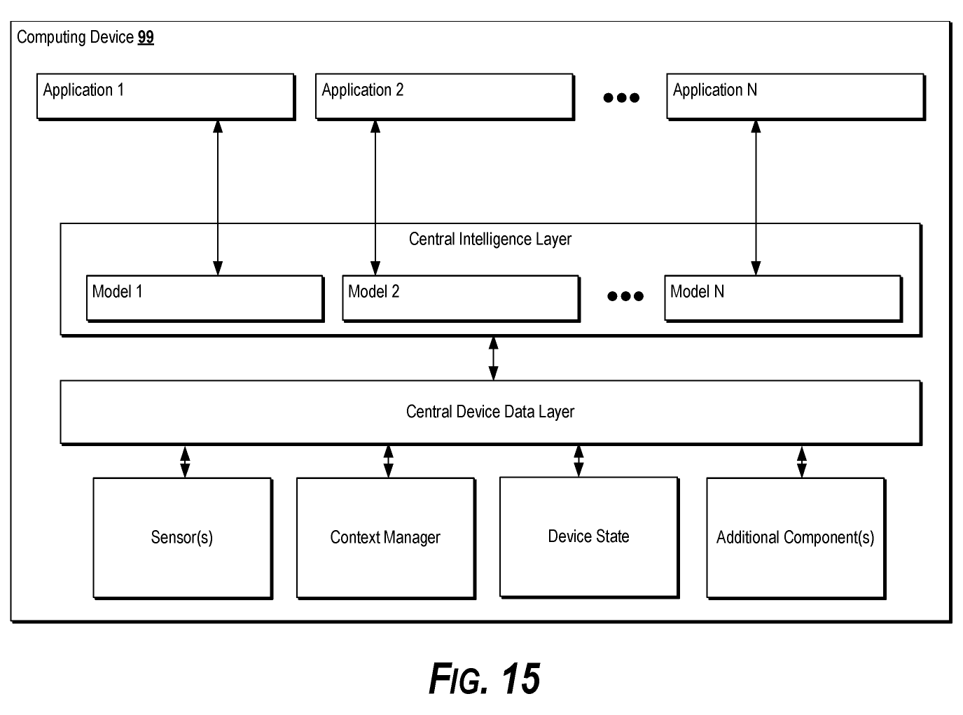

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
processing, by a computing system, a corpus of context data with a machine-learned model to generate, as output from the machine-learned model an initial transcript for audio content, wherein the initial transcript comprises description of one or more topics contained within the corpus of context data;
accessing data indicative of a user query;
transmitting a request for a content item comprising the user query and a subset of context data of the corpus of context data;
receiving, responsive to the request for the content item, a first content item; and
processing, by the computing system, the first content item with the machine-learned model to generate, as output from the machine-learned model an updated transcript for audio content, wherein the transcript comprises a transition from the initial transcript to a transcript that incorporates the first content item.

2. The computer-implemented method of claim 1, wherein the updated transcript comprises a first updated transcript and a second updated transcript, comprising:
generating, using the machine-learned model, by the computing system, the second updated transcript comprising speech content that is generated while first audio content generated from the first updated transcript is being provided for playback; and
providing, by the computing system, second audio content generated from the second updated transcript for playback after the first audio content is completed being provided for playback.

3. The computer-implemented method of claim 1, comprising:
processing, by the computing system, the updated transcript to generating audio content; and
providing, by the computing system, the audio content for playback.

4. The computer-implemented method of claim 1, wherein the user query comprises a question relating to a topic described within the initial transcript.

5. The computer-implemented method of claim 1, wherein the first content item comprises a product and a description of the product.

6. The computer-implemented method of claim 1, wherein the first content item comprises an outline for a transcript.

7. The computer-implemented method of claim 1, wherein the first content item comprises a preselected voice to be used for audio content that is generated from the updated transcript.

8. The computer-implemented method of claim 1, wherein the initial transcript is associated with a plurality of pre-selected content items, wherein the first content item comprises an item of the plurality of pre-selected content items.

9. The computer-implemented method of claim 1, wherein the first content item is selected using a real-time content selection process.

10. A computing system comprising:
one or more processors; and
one or more non-transitory computer-readable media storing instructions that are executable by the one or more processors to cause the computing system to perform operations, the operations comprising:
processing, by a computing system, a corpus of context data with a machine-learned model to generate, as output from the machine-learned model an initial transcript for audio content, wherein the initial transcript comprises description of one or more topics contained within the corpus of context data;
accessing data indicative of a user query;
transmitting a request for a content item comprising the user query and a subset context data of the corpus context data;
receiving, responsive to the request for the content item, a first content item; and
processing, by the computing system, the first content item with the machine-learned model to generate, as output from the machine-learned model an updated transcript for audio content, wherein the transcript comprises a transition from the initial transcript to a transcript that incorporates the first content item.

11. The computing system of claim 10, wherein the updated transcript comprises a first updated transcript and a second updated transcript, comprising:
generating, using the machine-learned model, by the computing system, the second updated transcript comprising speech content that is generated while first audio content generated from the first updated transcript is being provided for playback; and
providing, by the computing system, second audio content generated from the second updated transcript for playback after the first audio content is completed being provided for playback.

12. The computing system of claim 10, comprising:
processing, by the computing system, the updated transcript to generating audio content; and
providing, by the computing system, the audio content for playback.

13. The computing system of claim 10, wherein the user query comprises a question relating to a topic described within the initial transcript.

14. The computing system of claim 10, wherein the first content item comprises a product and a description of the product.

15. The computing system of claim 10, wherein the first content item comprises an outline for a transcript.

16. The computing system of claim 10, wherein the first content item comprises a preselected voice to be used for audio content that is generated from the updated transcript.

17. The computing system of claim 10, wherein the initial transcript is associated with a plurality of pre-selected content items, wherein the first content item comprises an item of the plurality of pre-selected content items.

18. The computing system of claim 10, wherein the first content item is selected using a real-time content selection process.

19. One or more non-transitory computer readable media storing instructions that are executable by one or more processors to perform operations comprising:
processing, by a computing system, a corpus of context data with a machine-learned model to generate, as output from the machine-learned model an initial transcript for audio content, wherein the initial transcript comprises description of one or more topics contained within the corpus of context data;
accessing data indicative of a user query;
transmitting a request for a content item comprising the user query and a subset of context data of the corpus of context data;
receiving, responsive to the request for the content item, a first content item; and
processing, by the computing system, the first content item with the machine-learned model to generate, as output from the machine-learned model an updated transcript for audio content, wherein the transcript comprises a transition from the initial transcript to a transcript that incorporates the first content item.

20. The one or more non-transitory computer readable media of claim 19, comprising:
processing, by the computing system, the updated transcript to generating audio content; and
providing, by the computing system, the audio content for playback.
